(19) United States
(12) Patent Application Publication
(10) Pub. No.: US 2004/0175603 A1
(43) Pub. Date: Sep. 9, 2004

(54) Durable and an easy refueling metal-gas battery with soft pocket

(76) Inventors: De-Qian Yang, Diamond Bar, CA (US); Yu-Qiang Yang, Diamond Bar, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/801,422

(22) Filed: Mar. 16, 2004

Related U.S. Application Data
(63) Continuation-in-part of application No. 10/231,878, filed on Aug. 28, 2002.
Application No. 10/231,878 is a continuation-in-part of application No. 09/683,120, filed on Nov. 20, 2001, now Pat. No. 6,630,262.

(51) Int. Cl. H01M 12/06; H01M 2/12

(52) U.S. Cl. 429/27; 429/82; 429/29; 429/86

(57) ABSTRACT

A metal-gas battery, such as a zinc-air battery, has one or more metal-gas cells. Each metal-gas cell has a metal anode sandwiched between a pair of gas cathodes. Each gas cathode is disposed within a rigid retaining structure. The retaining structures of each gas cathode are attached to one another by an expandable soft pocket capable of holding an electrolyte solution. The metal anode is disposed within the soft pocket without an enclosure separator bag. The metal-gas cell is mechanically refueled by expanding the soft pocket to allow easy removal from the cell of a spent anode and easy insertion into the cell of a fresh anode. In order to avoid the unpredicted electrolyte leakage, the gas diffusion electrodes are installed on the soft pocket to instead of a rigid cell housing to eliminate the stress created by different coefficients of thermal expansion of materials.

### CROSS-REFERENCE TO RELATED APPLICATION

This application is a continuation-in-part of U.S. Pat. No. 6,630,262, filed Nov. 20, 2001 under the title of “Metal-Gas Cell Battery with Soft Pocket, and a continuation-in-part of U.S. application Ser. No. 10/231,878, filed Aug. 28, 2002 under the title of “An Easy Refueling Metal-Gas Cell Battery With Soft Pocket”, the full disclosures of which are incorporated herein by reference.

### BACKGROUND OF THE INVENTION

1. Field of Invention

The present invention generally relates to metal-gas batteries, such as metal-air batteries. More particularly, the present invention relates to mechanically rechargeable metal-air batteries.

2. Description of Related Art

More powerful and longer-lasting batteries are a high priority item for all countries seeking to replace hydrocarbon-fueled vehicles with smogless, electrically powered vehicles. In this regard, a great deal of research is thus presently focused on metal-gas batteries, such as zinc-air batteries. Zinc-air batteries have the highest theoretical specific energy content of all known battery types. Many problems, however, must be overcome before vehicles are powered by zinc-air batteries, which are regarded as acceptable alternatives to vehicles burning hydrocarbon fuel.

All metal-gas batteries comprise a plurality of cells. Each of the cells has at least a gas cathode and a metal anode separated by a quantity of alkaline electrolyte and some form of mechanical separator sheet. During the operation of metal-gas batteries, a reactant gas, such as oxygen, reacts at each gas cathode to form hydroxide ions, and these hydroxide ions, in the alkaline electrolyte, react with metal anode material at each metal anode. The process creates an electrical potential between each gas cathode and each metal anode. When the cells are connected in series, the combined electrical potential of all cells is considerable and can be used as a source of electrical power. As can be seen, however, the operation of the battery gradually depletes the available metal anode material. Therefore, the battery has to be periodically recharged.

Metal-gas batteries can be recharged either electrically or mechanically. Electrical recharging can be easily adapted to the existing power networks, but the service life of the electrically rechargeable metal-gas battery is markedly limited. Moreover, an electrically rechargeable metal-gas battery requires a bifunctional or an additional gas diffusion electrode. Due to the need for such a bifunctional or additional gas diffusion electrode, the battery is unduly heavy, bulky and complicated.

Accordingly, the current preferred recharging mode for metal-gas batteries is mechanical refueling, whereby the spent metal anode is physically replaced with a fresh metal anode. Mechanical refueling can be accomplished in two ways. When the metal anode comprises metallic pellets or powder suspended within the electrolyte, the spent metallic pellets or powder is pumped from the cell and fresh metallic pellets or powder is pumped into the cell. U.S. Pat. Nos. 3,981,747, 5,006,424, 5,434,020 and 5,558,947 disclose attempts to use zinc particles or pellets as anodes.

An even simpler method of mechanical refueling is possible if the metal anode is a rigid structure, for example, made of a conductive support packed with zinc powder. The spent metal anode is removed and a fresh metal anode is reinstalled into the cell. This refueling method is generally employed because of its theoretical, construction, maintenance and operation simplicity. U.S. Pat. Nos. 3,513,030, 5,208,526, 5,318,861, 5,366,822, 5,418,080, 5,447,805, 5,753,384, 5,904,999 and 6,057,052 all disclose various methods of mechanically refueling metal-gas batteries by replacing the spent rigid anode structure. Each of the patents listed is incorporated herein by reference in its entirety.

One problem with such conventional metal-gas batteries is that the rigid anode structures are difficult to remove from and insert into the cell. In a conventional cell where the housing of the cell is wholly rigid, clearances for the removal and reinsertion of such anodes are generally very small. The gas cathodes and separator sheets are often abraded during the removal and reinsertion of the anodes. U.S. Pat. Nos. 4,389,466 and 4,560,626 disclose an attempt to solve this problem. However, in these patents, the total contact area between the cone-shaped current collectors and the metal anodes of the metal-gas batteries is not sufficiently large for large currents. Moreover, pinpoints on the current collectors often make the insertion and extraction of the metal anodes very difficult. Another attempt to solve this problem is disclosed in U.S. Pat. No. 5,286,578. In this patent, a collapsible electrochemical cell made by “a flexible plastic material” is suggested to satisfy its collapsible design. No detail of the flexible plastic material is disclosed. However, such housing system is fragile and cannot withstand repeated refueling. Other wholly flexible housing systems are disclosed in U.S. Pat. Nos. 5,415,949 and 5,650,241. Such housing systems are unduly complex and are therefore expensive to manufacture, maintain and operate.

U.S. Pat. Nos. 4,389,466 and 4,560,626 disclose a soft bladder to press the zinc anode against the multi-points and cone-shaped current collector. These designs have many problems and are not discussed here. In fact, no commercial product on the market comes even close to the designs described in these patents.

Another problem with metal-gas batteries, which are mechanically refueled by physical replacement of a rigid anode structure, is the frequent leakage of the alkaline electrolyte. In most prior art designs, the housing of the metal-gas cell is usually opened at the top. The opening is sealed during operation by an elastic sealing element disposed between the cell housing and a protruding portion of the anode assembly. This protruding portion of the anode assembly is universally used in such designs for electrical connection to other cell or battery electrodes. Moreover, it is common to provide one or two small breathing holes along the uppermost portion of the cell proximal to the protruding portion of the anode. However, alkaline electrolyte tends to creep up the metal anode and out of the cell along the protruding portion of the anode. Also, alkaline mist continuously escapes through the breathing holes. Such leakage and mist can cause rapid oxidation of the conductors of the metal anode and the air cathode. Oxidation dramatically increases the electrical resistance between the contact surfaces and therefore results in a marked loss of battery power. Moreover, the continual leakage of alkaline electrolyte and electrolyte mist makes the battery difficult to use in any kind of environment where oxidation of metallic items outside the battery is a problem. Finally, any upset of the battery during handling or operation will cause copious leakage of alkaline electrolyte out of the battery.

As a matter of fact, secondary zinc-air fuel cells or batteries, no matter whether mechanically refuelable or electrically rechargeable, have not been manufactured on a large scale as a commercial product. Only a primary zinc-air button cell and a zinc-air battery, which are not rechargeable, for navigation lamps can be found on the market at present. This is because no one has yet solved the problem of the separator.

All the secondary zinc-air batteries having zinc electrode suffer from a short service life because the batteries are short-circuited by zinc dendrites growing from the zinc electrode during recharging. The sharp zinc dendrites stab the separator like needles and bridge the zinc anode to the air cathode. Therefore, short circuits often occur. Batteries like Ni—Zn battery, Ag—Zn battery and the electrical rechargeable zinc-air fuel cells have the same serious problems due to frequent recharging. Theoretically, the mechanically refuelable secondary zinc-air fuel cell should not suffer from this problem, as it is not electrically recharged. However, the mechanically refuelable zinc-air fuel cells do suffer this problem, although with lesser frequency. Even at a lesser frequency, it is still a serious problem, as when even one cell in a multi-cell module is short-circuited, the whole module fails.

The principle by which unpredicted zinc dendrites occasionally grow and cause short circuits is not clear yet, but may be due to the following reason. During the discharge of the uneven density of the zinc powder distribution on the anode plate, the electrical potential is different in different locations on the zinc electrode. As a result of reducing zincates in the alkaline electrolyte to deposit metal zinc on the zinc anode surface, the zinc dendrites are formed at lower potential locations of the zinc electrode. These dendrites rapidly span the narrow gap between the anode and the cathode to short the cell. Therefore, the previous art designs either cannot avoid occasional short circuits or must sacrifice significantly the performance of the cell.

To avoid the zinc dendrites causing short circuits, in the traditional zinc-air battery used for powering a navigation lamp, the zinc electrode is usually wrapped in multiple layers of separator paper to enhance resistibility thereof to stabbing by zinc dendrites. Additionally, the distance from the air cathode to the zinc anode is enlarged to about 10 mm or more, so that the zinc dendrites cannot grow long enough to reach the air cathode. As the result of increasing the electric resistance of the multiple layers of separator paper and the thickness of the electrolyte, the internal resistance of the cell is increased, too. Hence, this kind of zinc-air battery can only deliver low power; it is enough to power a navigation lamp or a unit of communication equipment, but not adequate to power an electric vehicle.

Mechanically refuelable secondary zinc-air fuel cells are expected to have a service life that is a few hundred times longer than the disposable zinc-air fuel cells. The separator is too expensive to be renewed during every refueling; the separator has to be reusable over the whole service life of the zinc-air fuel cells. U.S. Pat. No. 5,418,080 discloses a 400-mesh fabric separator bag employed in a zinc-air fuel cell. This separator bag is made of polypropylene fabric or polymeric amide and is expected to be strong enough to work in an alkaline electrolyte for several years. But the separator bag needs to be slipped onto the zinc anode plate and has to be washed after every discharge. Otherwise, zinc oxide residue tends to block the pores of the fabric as well as the transfer of ions, which ions would otherwise penetrate the pores of the fabric to transfer electricity between the cathode and the anode. As a result, the output power is lowered from time to time. U.S. Pat. No. 5,431,823 also discloses a specially designed tool for washing the separator bag. Even with this specially designed washing tool, the separator bags have to be manually slipped onto and removed from the washing tools. Besides, the separator bags have to be manually slipped onto and removed from the zinc anodes as well. If the huge quantity of anodes and separator bags when hundreds of thousands of zinc-air fuel cells are in use is considered, this labor-intensive processing is obviously too expensive to be a real commercial solution, even in developing countries.

Furthermore, although, by visual observation, the 400-mesh fabric has a fine and close texture, its openings are too large to prevent the zinc dendrites from passing through. Therefore, the short circuit caused by zinc dendrites cannot be avoided for sure.

Kummrow's zinc-air battery uses fabric as the separator bag, too. Slightly differing from U.S. Pat. No. 5,418,080, it uses a thicker fabric. In order to prevent short circuits caused by zinc dendrites, a polypropylene box with big holes on its two major surfaces is used to envelop the zinc anode and its separator bag. Therefore, it entails not only the expensive, labor-intensive operation of changing and washing the separator bags, but also the additional operations of changing and washing the polypropylene boxes. Furthermore, the gaps between the zinc anodes and the air cathodes are increased to about 10 mm. This construction may not suffer from short circuits caused by zinc dendrites, but the power output is significantly reduced. It may suitable for low power use, but definitely is not suitable for high power requirements, such as electric vehicles.

From the commercial point of view, the expensive labor-intensive operation of changing and washing the separator bags has to be eliminated; the separator has to be installed permanently in the zinc-air fuel cell. Consequently, none of the existing constructions solves the problem caused by zinc dendrites short circuits.

Another serious problem arises when the separator is permanently installed in the zinc-air fuel cell. The pores of the separator are passages for the hydroxide ions. If the pores are blocked by zinc oxide, the hydroxide ions are blocked, too. Hence the zinc anode will be hungry from lack of hydroxide ions, and the power output will decrease over time as the openings of the separator are increasingly blocked. Even when the discharging current is turned off, the pores of the micro-porous separator are plugged by the precipitation of zincates to zinc oxide from the electrolyte.

The function of a separator for commercial secondary zinc-air fuel cell should mechanically separate the gas cathode and the metal anode and also have the following characteristics: (1) The separators have to be absorptive and readily allow the transport of hydroxide ions to reduce the electrical resistance of the zinc-air fuel cell. (2) The separators have to be impermeable to zincates. (3) The separators have to be chemically stable in the alkaline electrolyte environment. (4) The separators have to be resistant to penetration by zinc dendrites. (5) The pores of the separators must avoid blockage by precipitation of zinc oxide. (6) The separators must last for the whole service life of the zinc-air fuel cells. (7) The separators must as cheap as possible.

The separator is one of the keys to the performance and durability of the secondary zinc-air fuel cells and batteries. The separator's ability to control the exchange of ions plays a limiting role in determining maximum power-to-weight ratio; this is especially important for the zinc-air fuel cells for powering electric vehicles.

Attempts to avoid the dendrite-shorting problem using metal or metal oxide as barrier layers are illustrated in U.S. Pat. Nos. 3,539,396 and 4,298,666. Nickel powder is commonly used in these patents because it reacts with the zinc dendrites as a micro cell to prevent the continuous growing of the dendrites. Separators selected from the above patents could be the solution to the separator problem for the zinc-air rechargeable battery, although they are expensive.

For mechanically refuelable zinc-air fuel cells, no matter whether its discharged anode has to be replaced or recharged in another recharging cell, the separators with metal or metal oxide barrier layer are not necessary. Separators selected from the following patents may be good enough for mechanically refuelable zinc-air fuel cells. U.S. Pat. Nos. 4,154,912, 4,272,470 and 6,033,806 disclose a graft polyvinyl alcohol separator, which may be effective to avoid dendrite short-circuiting.

In U.S. Pat. No. 4,359,510, a novel separator structure is disclosed. A hydrophobic micro-porous non-woven web is first treated with a wet agent and then coated with cellulose on both sides. This manufactured separator has a low ionic resistance, good hydrophilic ability, dendrite-shorting resistance, and pore-plug resistance.

### SUMMARY OF THE INVENTION

In one aspect, the present invention provides a metal-gas battery that can be conveniently recharged by mechanically replacing the metal anode.

In another aspect, the present invention provides a metal-gas battery that can eliminate the expensive and labor-intensive operation of changing and washing the separator bags.

In still another aspect, the present invention provides a metal-gas battery that does not leak electrolytes or electrolyte mist.

In a further aspect, the present invention provides a metal-gas battery suitable for rapid refueling and sufficiently durable for hundreds of refueling operations.

In accordance with the foregoing and other aspects of the present invention, the invention describes a metal-gas battery comprising at least one metal-gas cell. A metal-gas battery comprises at least one metal-gas cell, and each metal-gas cell comprises elements as follows. A soft pocket having a flexible and planar first wall and a flexible and planar second wall are made of an elastic and alkaline-resistant material. The periphery of the first wall is connected to the periphery of the second wall except along respective top edges of the first wall and the second wall. A first group of threads and a second group of threads are vertically arranged and respectively glued onto the periphery of the first wall and the second wall of the soft pocket to form a gas passage between adjacent threads. A first gas cathode and a second gas cathode are glued to the first wall and the second wall of the soft pocket, respectively, and the first gas cathode is electrically connected to the second gas cathode. The first gas cathode and the second gas cathode are permeable to air but impermeable to liquids to allow gases to enter into the metal-gas cell. The first gas cathode, the first wall, the second wall, and the second gas cathode cooperate to define a liquid-retaining soft pocket chamber having a lower portion, an upper portion and a top opening defined between the top edges of the first and the second walls of the soft pocket. A first soft plate with a central opening is used to help seal the first cathode to the first wall of the soft pocket, and a second soft plate with a central opening is used to help seal the second cathode to the second wall of the soft pocket to avoid electrolyte leakage. The first and the second soft plate are made of the same material with the soft pocket. A rigid planar first retaining structure is attached to the periphery of the first wall of the soft pocket, and a rigid planar second retaining structure is attached to the periphery of the second wall of the soft pocket. The second retaining structure is moveable with respect to the first retaining structure between a first retaining structure position, in which the first retaining structure is proximal to the second retaining structure to close tightly the top opening of the soft pocket chamber, and a second retaining structure position, in which the first retaining structure is spaced apart from the second retaining structure to open the top opening of the soft pocket chamber. A metal anode is disposed within the soft pocket chamber. Two sheets of separator are permanently and respectively installed between the first gas cathode and the first group of threads, and between the second gas cathode and the second group of threads, respectively. A sub-assembly is located at the upper-most position of the soft pocket. The sub-assembly is permeable to air but impermeable to liquids in order to reduce the pressure difference between the soft pocket chamber and the outside atmosphere.

The battery further comprises a positive battery terminal electrically connected to the first and the second gas cathodes and a negative battery terminal electrically connected to the metal anode.

In a typical embodiment of the invention, the first and the second gas cathodes are air cathodes and the metal anode is substantially made of metallic zinc.

In a preferred embodiment of the invention, the metal anode is wholly disposed within the soft pocket chamber.

In another embodiment of the invention, a semi-permeable membrane is disposed within the sub-assembly to reduce the pressure difference between the soft pocket chamber and the outside atmosphere.

In still another embodiment of the invention, the soft pocket can be made of thermoplastic rubber (TPR) or thermoplastic elastomer (TPE) etc. For example, polypropylene (PP), neoprene, ethylene propylene diene monomer (EPDM), butyl rubber, ethylene-propylene copolymer, or chlorosulfonated polyethylene can be used to make the soft pocket.

In yet another embodiment of the invention, all edges of the metal anode are rounded to avoid dropping metal powder.

In further another embodiment of the invention, the metal anode is hung firmly within the soft pocket by a hook when the first and the second retaining structures are in the first retaining structure position.

In further another embodiment of the invention, the first and the second gas cathodes are electrically connected by at least a pair of metal contacts extended upward above the top opening of the soft pocket.

In further another embodiment of the invention, the electrolyte has to be nearly saturated with zinc oxide at a concentration of preferably about 20-50 g/L, and more preferably about 35-40 g/L to avoid the growth of the zinc dendrites on the metal anode.

In further another embodiment of the invention, four elbow tubes are inserted into the four corners of the gap between each pair of the separator and the gas cathode.

In light of the forgoing, the first and the second gas cathodes are glued onto the soft pocket made of elastic material, preferably TPR or TPE, and the rigid planer structures are only used as the frames to hold the soft structure, such as the first and the second gas cathodes and the soft pocket, in the right shape. Therefore, the soft pocket can expand with the expansion of the first and the second gas cathodes with negligible stress to avoid electrolyte leakage. Furthermore, the semi-permeable membrane is disposed in the sub-assembly located at the upper-most position of the soft pocket to avoid blocking by the electrolyte, and thus there is sufficient space for gases generated within the soft pocket chamber to release quickly the internal pressure. Moreover, all metal contacts for electrically connecting the first and the second gas cathodes, the anode conductor and the cathode conductor are extended upward and located above the top opening of the soft pocket chamber to avoid exposure to the electrolyte and possible electrolyte leakage.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view of a metal-gas battery according to a preferred embodiment of the invention;

FIG. 2 is a perspective view of a metal-gas cell useable in the metal-gas battery of FIG. 1;

FIG. 3 is an exploded view of the metal-gas cell (without metal anode) shown in FIG. 2;

FIG. 4 is a cross-sectional view taken along C-C of the opened soft pocket in FIG. 3;

FIG. 5 is a cross-sectional view taken along DD or EE of the opened soft pocket of FIG. 3;

FIG. 6 is an exploded view of the sub-assembly 32 shown in FIG. 3;

FIG. 7 is a cross-sectional view taken along F-F of the sub-assembly 32 of the metal-gas cell shown in FIG. 3;

FIG. 8 is a cross-sectional view taken along A-A from FIG. 2; and

FIG. 9 is a cross-section view taken along B-B from FIG. 2.

FIG. 10 shows a typical corner of the separator and the elbow tube.

FIG. 11 is an enlarged view to show the slots for the installation of the threads and the elbow tubes.

### DESCRIPTION OF THE PREFERRED EMBODIMENTS

Reference will now be made in detail to the present preferred embodiments of the invention, examples of which are illustrated in the accompanying drawings. This discussion should not be construed, however, as limiting the invention to those particular embodiments. Practitioners skilled in the art will recognize numerous other embodiments as well. Wherever possible, the same reference numbers are used in the drawings and the description to refer to the same or like parts.

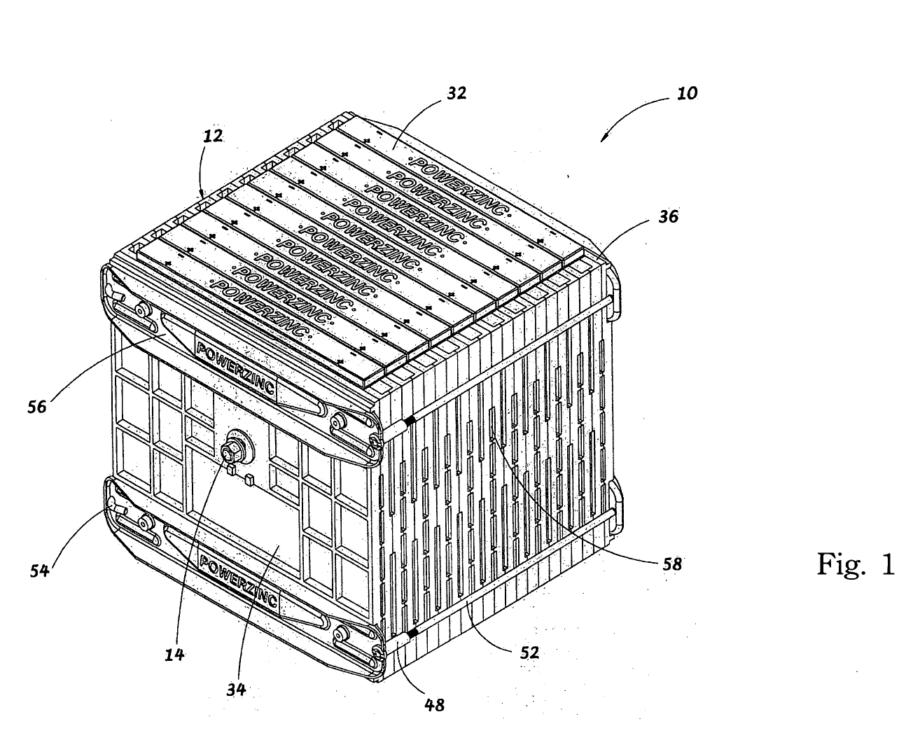

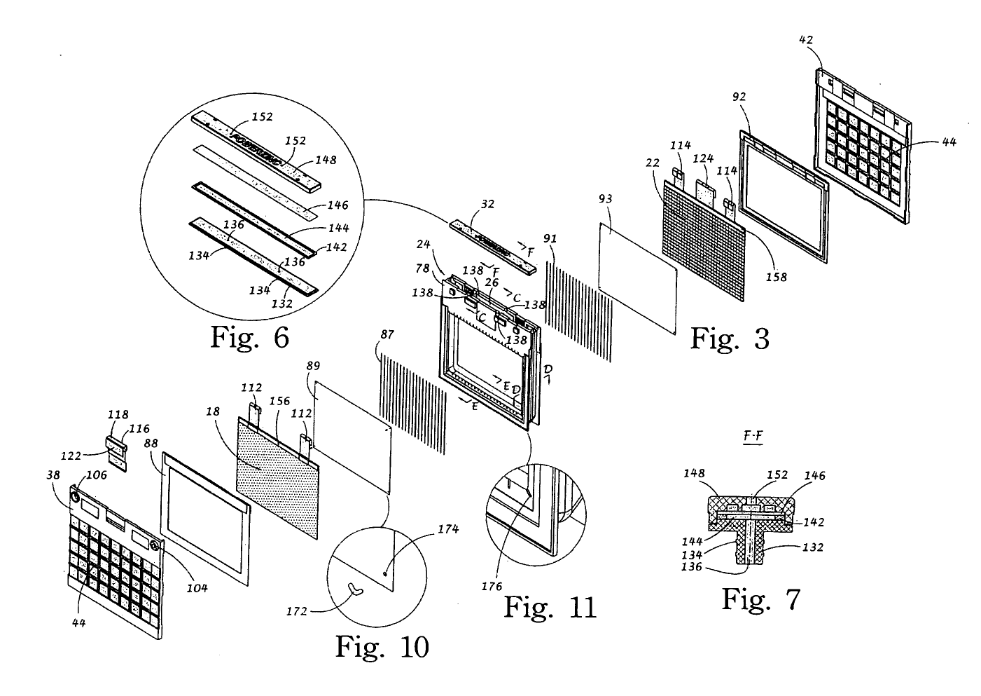

In accordance with the foregoing and other needs, the invention provides a metal-gas battery. FIG. 1 is a perspective view of a metal-gas battery according to a preferred embodiment of the invention. In FIG. 1, a metal-gas battery 10 comprises a plurality of metal-gas cells 12 connected in series, a positive battery terminal 14 on a front cover plate 34 and a negative battery terminal (not shown) on a rear cover plate 36. The front cover plate 34 protects the outermost first gas cathode 18 in the first metal-gas cell 12 (in FIG. 3), and the rear cover plate 36 protects the outermost second gas cathode 22 (in FIG. 3) in the last metal-gas cell 12.

In FIG. 1, the positive battery terminal 14 can be a male cone-shaped or cylindrical shaped structure disposed in the front cover plate 34. The negative battery terminal (not shown) can be a corresponding female cone-shaped or cylindrical shaped structure disposed in the rear cover plate 36. The positive battery terminal 14 is electrically connected to the first and the second gas cathodes 18 and 22 (in FIG. 3). The negative battery terminal is electrically connected to the metal anode 28, which adjoins the second battery terminal.

A reactive gas used for the gas cathode of the metal-gas battery 10 is oxygen, such as from air, and the anode material is zinc or similar material. In FIG. 1, air for providing cooling and reactive oxygen to the metal-gas battery 10 flows through gaps 58 between the neighboring metal-gas cells 12. The number of metal-gas cells 12 of the metal-gas battery 10 depends upon what voltage is desired.

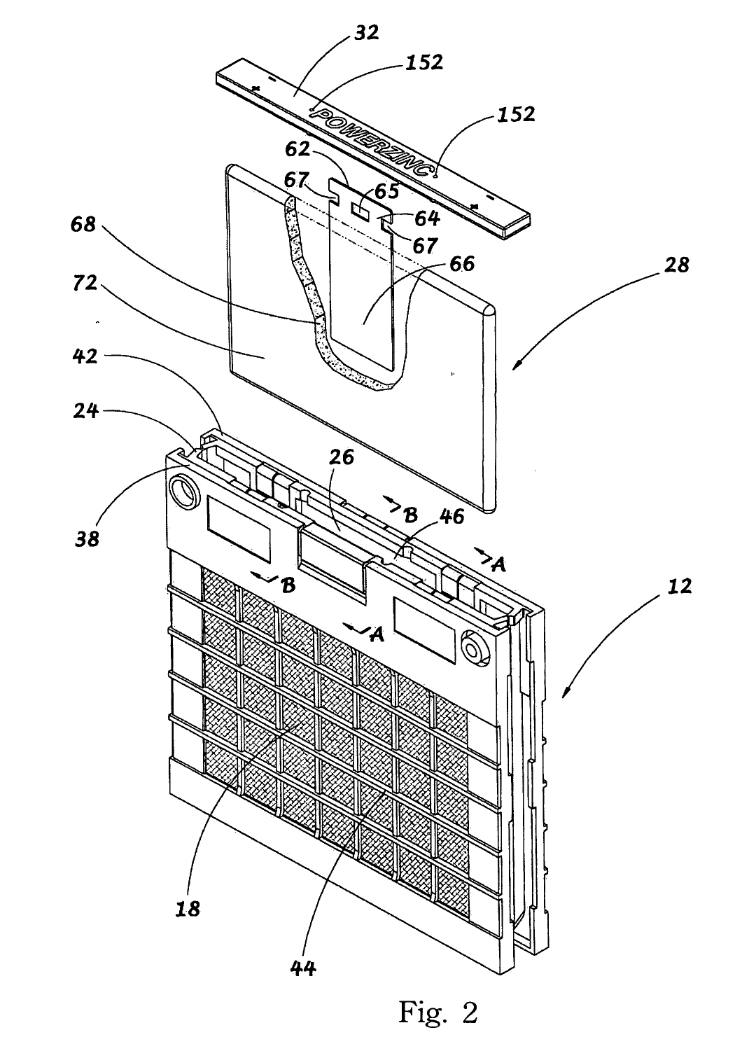

FIG. 2 is a perspective view of a metal-gas cell useable in the metal-gas battery of FIG. 1. In FIG. 2, the metal-gas cell 12 comprises a first gas cathode 18, a second gas cathode 22 (not shown in FIG. 2, but shown in FIG. 3) and a soft pocket 24 disposed between the first gas cathode 18 and the second gas cathode 22. The soft pocket 24 defines a soft pocket chamber 26. Each metal-gas cell 12 further comprises a metal anode 28 disposed within the soft pocket chamber 26.

In a preferred embodiment, the metal anode 28 in FIG. 2 is wholly disposed within the soft pocket chamber 26. The metal anode 28 comprises a support structure 62 having an upper portion 64 and a lower portion 66. The upper portion 64 has a central opening 65 and two hatches 67. Therefore, the metal anode 28 can be hung through the central opening 65 on the right position within the soft pocket 24, details of which will be further described with reference to FIG. 9. The two hatches 67 are designed to ensure that inserting the metal anode 28 into and pulling the metal anode 28 out from the soft pocket 24 can be easily done in a mechanical way such as using a machine hook to hook the two hatches 67. Accordingly, the efficiency of the process for assembling the metal-gas cell 12 is increased and the labor cost is thus decreased. Metal powder 68, such as zinc powder, is pressed onto the lower portion 66 of the support structure 62 to form an anode base portion 72. After numerous experiments, it is found that the sharp edge of the metal anode 28 can cause serious problem. As a matter of fact, the zinc particles at the sharp edge of the metal anode 28 are easily broken off from the metal anode 28 and dropped into the gap between the metal anode 28 and the first gas cathode 18 or the second gas cathode 22. Although the first and the second gas cathodes 18 and 22 are respectively covered with a sheet of the first separator 89 and the first group of threads 87, and the second separator 93 and the second group of threads 91 (as shown in FIG. 3), the local short circuit is still a possibility. To prevent this possible break-off of zinc particles, all the edges of the anode base portion 72 are rounded to avoid the unexpected breaking off of the zinc particles.

In FIG. 2, the upper portion 64 and the lower portion 66 of the support structure 62 can be made of any conductive material. Therefore, the support structure 62 is electrically conductive. Copper is preferably used for the support structure 62 because of its low cost, rigidity and high conductivity. The upper portion 64 should be rigid enough to minimize damage or distortion during recycling and provide a large cross-sectional area to allow high current flow with minimal voltage drop. However, larger cross-sectional area of the support structure 62 means more weight of the metal-gas battery 10. In this preferred embodiment, the electrical conductive support structure 62 of the metal anode 28 is re-designed to be merely a piece of rectangular copper sheet. It is proven, for small size of the metal-gas cell 12, that this rectangular shaped electrical conductor is not only quite enough for electrical current transmission, but also saves cost and weight as well as the labor for recycling.

Each metal-gas cell 12 further comprises a sub-assembly 32 with two ventilation holes 152 being permeable to air but impermeable to liquids in order to reduce the pressure difference between the soft pocket chamber and the outside atmosphere.

FIG. 3 is an exploded view of the metal-gas cell (without the metal anode 28) shown in FIG. 2. In FIG. 3, the first gas cathode 18 is permeable to the reactive gas but impermeable to liquids. When the reactive gas is atmospheric oxygen, the first gas cathode 18 allows the passage of oxygen from the atmosphere into the metal-gas cell 12. The second gas cathode 22 also is permeable to the reactive gas but impermeable to liquids. When the reactive gas is atmospheric oxygen, the second gas cathode 22 allows the passage of oxygen from the atmosphere into the cell 12. Both the first gas cathode 18 and the second gas cathode 22 comprise a supporting lattice structure 44 that allows sufficient air to flow through the first gas cathode 18 and the second gas cathode 22.

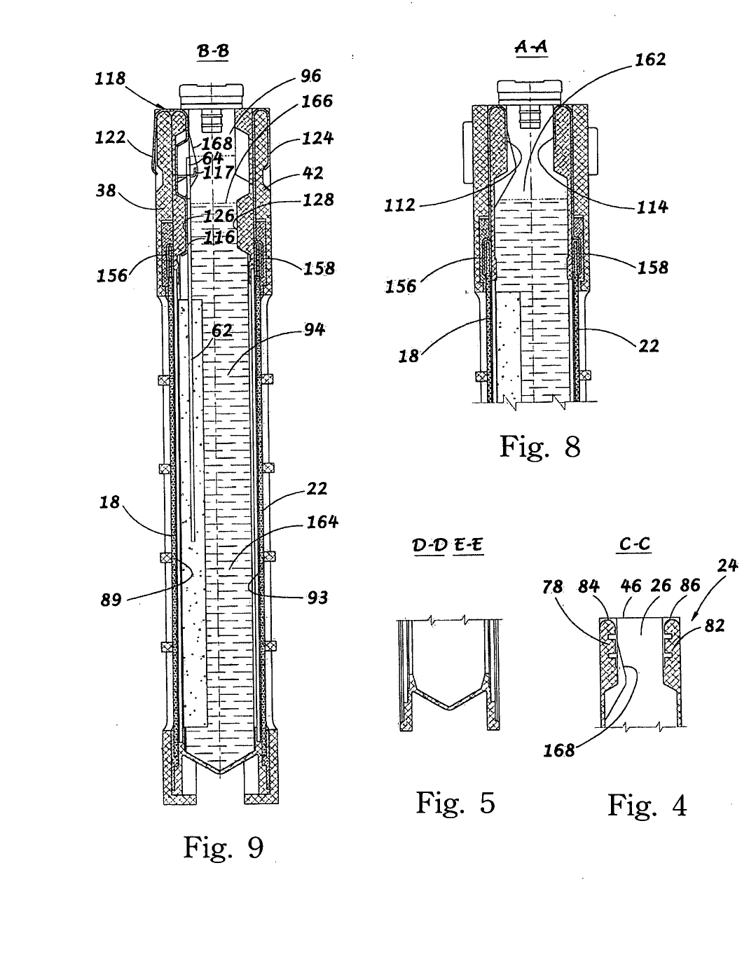

In FIG. 3, the first retaining structure 38 is glued to the periphery of the first planar wall 78 of the soft pocket 24, and the second retaining structure 42 is glued to the periphery of the second planar wall 82 (shown in FIG. 4) of the soft pocket 24. The first retaining structure 38 is moveable with respect to the second retaining structure 42 between a first retaining structure position and a second retaining structure position. The first retaining structure 38 is proximal to the second retaining structure 42 when the first and the second retaining structures 38 and 42 are in the first retaining structure position. The first retaining structure 38 is spaced apart from the second retaining structure 42 when the first and the second retaining structures 38 and 42 are in the second retaining structure position.

FIG. 4 is a cross-sectional view taken along C-C of the opened soft pocket 24 in FIG. 3. In FIG. 4, the soft pocket 24 has a top opening 46. The top opening 46 is opened when the first and the second retaining structures 38 and 42 are in the second retaining structure position. The top opening 46 is tightly closed when the first and the second retaining structures 38 and 42 are in the first retaining structure position. “Tightly closed” means that the top opening 46 is sufficiently sealed to prevent the leakage of electrolyte or electrolyte fumes from the soft pocket chamber 26.

Referring to FIG. 1 again, the soft pockets 24 of the series connected metal-gas cells 12 can be closed for securing the first and the second retaining structures 38 and 42 in the first retaining structure position. In FIG. 1, the soft pocket closing mechanism can be nuts 48 and screws 52 with elbows 54 protruding from the front cover plate 34 to the rear cover plate 36 and the four outmost reinforced metal fittings 56. This closing mechanism allows the metal-gas battery 10 to be more easily assembled by inserting the elbows 54 to tighten the reinforced metal fittings 56 and screws 52 in the nuts 48. In contrast with the traditional method, there is no need to screw on the two nuts 48.

In order to show clearly the construction of the soft pocket 24 in FIG. 3, cross-sectional views C-C, D-D, and E-E are shown in FIGS. 4 and 5. The cross section shown in FIG. 5 is designed to ensure sufficient flexibility of the soft pocket 24. In FIG. 4, the soft pocket 24 has a flexible and planar first wall 78 and a flexible and planar second wall 82. The periphery of the first wall 78 has a top edge 84, and the periphery of the second wall 82 has a top edge 86. The periphery of the first wall 78 is connected to the periphery of the second wall 82 except along the respective top edges 84 and 86. Two protrusions 168, which are separately located on both sides of the metal anode 28, extend from the inner surface of the first wall 78 of the soft pocket 24 and are designed to protect the metal anode 28, and the details will be described with reference to FIG. 9.

As shown in FIG. 3, the first group of threads 87, the first separator 89, the first gas cathode 18, the first soft plate 88 with a central opening and the first retaining structure 38 are respectively attached to the first wall 78; the second group of threads 91, the second separator 93, the second gas cathode 22, the second soft plate 92 with a central opening and the second retaining structure 42 are respectively attached to the second wall 82. The first gas cathode 18, the second gas cathode 22 and the soft pocket 24 define a soft pocket chamber 26 (shown in FIGS. 2 and 9) for retaining liquid.

The soft pocket chamber 26 has a lower portion 94, an upper portion 96 (shown in FIG. 9) and a top opening 46 (shown in FIG. 4). The top opening 46 is defined between the top edges 84 and 86 of the first wall 78 and the second wall 82, respectively. The top opening 46 is open when the first and the second retaining structures 38 and 42 are in the second retaining structure position and tightly closed when the first and the second retaining structures 38 and 42 are in the first retaining structure position.

Due to the frequent starting and stopping and operation in different seasons throughout the long period of service life of the conventional metal-gas battery, the different thermal expansion coefficient of the gas cathode, the plastic casing and the epoxy glue between them may fatigue the adhered interface. Thus, the leakage of the electrolyte may happen. In the preferred embodiment of the present invention, the first and the second gas cathodes 18 and 22 are respectively glued onto the first and the second walls 78 and 82 of the soft pocket 24. The soft pocket 24 is made of elastic material, such as thermoplastic elastomer (TPE) or thermoplastic rubber (TPR), to allow expanding together with the first and the second gas cathodes 18 and 22. The same material of the soft pocket dissolved in a proper solvent can be the glue. For example, thermo plastic elastomer dissolved in toluene can be the glue for a soft pocket made of thermoplastic elastomer. Hence, there is no stress to cause the cracking and separation of the glued interface respectively between the first gas cathode 18 and the first wall 78, and the second gas cathode 22 and the second wall 82 of the soft pocket 24.

Any elastic material capable of resisting the electrolyte deterioration can be used to make the soft pocket 24. These materials include TPR and TPE. For example, polypropylene (PP), neoprene, ethylene propylene diene monomer (EPDM), butyl rubber, ethylene-propylene copolymer, or chlorosulfonated polyethylene can be used to make the soft pocket. Although any material possessing the features of alkaline-resistant and elasticity can be used to make the soft pocket, TPE is found to be the preferred material for the soft pocket. The reasons are that TPE can be molded to be the soft pocket without time-consuming vulcanization, and its elasticity can be maintained up to about 70° C. Furthermore, TPE is much lighter than any other kind of rubber materials.

The round sectional first group of threads 87 is vertically glued onto the periphery of the first wall 78 of the soft pocket 24 to protect the first separator 89; the round sectional second group of threads 91 is glued onto the periphery of the second wall 82 of the soft pocket 24 to protect the second separator 93. The first group of threads 87 and the second group of threads 91 can be made with a plastic and alkaline-resistant material, such as polypropylene (PP) or nylon. Moreover, the gaps between the adjacent threads of the first group of threads 87 together with the first separator 89 and the metal anode 28, and of the second group of threads 91 together with the second separator 93 and the metal anode 28 also form gas flow channels to release the hydrogen generated by self-discharge or any other possible gas generated, since any gas bubbles trapped between the metal anode 28 and the first and the second gas cathodes 18 and 22 can significantly reduce the power of the metal-gas cell 10 because the transfer capability of the hydroxide ions is reduced. Although a required distance is effectively kept between the metal anode 28 and the first and second separators 89 and 93, the reaction surfaces of both the metal anode 28 and the first and the second gas cathodes 18 and 22 are almost unaffected by the presence of threads.

A sheet of the first separator 89, between the first gas cathode 18 and the first group of threads 87, is permanently installed on the first wall 78 of the soft pocket 24; a sheet of the second separator 93, between the second gas cathode 22 and the second group of threads 91, is permanently installed on the second wall 82 of the soft pocket 24. Thus, during refueling, the replacement of the metal anode 28 is much more convenient. Moreover, the separator bags do not need to be changed and washed, and the expensive and labor-intensive operation is therefore eliminated.

The first soft plate 88 and the second soft plate 92 are made of the same material as the soft pocket 24. The first soft plate 88 and the second soft plate 92 are respectively glued to the first wall 78 and the second wall 82 of the soft pocket 24 to seal respectively the first gas cathode 18 and the second gas cathode 22, and the leakage between the jointed surfaces is thus avoided.

Both of the first and the second retaining structure 38 and 42 have one raised cylinder 104 and one sunken cylinder 106. The outer diameter of the raised cylinder 104 is made to match the inner diameter of the sunken cylinder 106, so that any number of metal-gas cells 12 can be aligned in the metal-gas battery 10 as shown in FIG. 1. The rigid planar first and second retaining structures 38 and 42 are used only to maintain the required shape of the cell and the passages between the cells for the required air, and they do not function as a part of the soft pocket chamber. Since the rigid planar first and second retaining structures 38 and 42 are no longer in contact with the electrolyte, the metal-fittings (shown in application Ser. No. 10/231,878) used to respectively clamp the edges of the first retaining structures 38 and the first walls 78 of the soft pocket, and the second retaining structures 42 and the second walls 82 of the soft pocket together can be omitted. Consequently, both the cost and the weight of the metal-gas cell 12 can be significantly reduced. Moreover, the problems, such as cracking of the sealed surface and leakage of electrolyte solution, caused by the different thermal expansion coefficients of the metal fitting and the plastic first and second retaining structures 38 and 42 used in the related previous patent can be resolved, too.

Without external forces, the top opening 46 of the soft pocket 24 is opened, as shown in FIG. 4. The electrical contacts 112 of the first gas cathode 18 and the electrical contacts 114 of the second gas cathode 22 (shown in FIG. 3) are pressed to close the top opening 46 of the soft pocket 24. The pressure needed to close the top opening 46 of the soft pocket 24 is evenly distributed along the whole length of the top opening 46 of the soft pocket 24, so that a more reliable sealing of the soft pocket 24 is obtained.

In FIG. 3, the contact surface 122 of the anode conductor 118 is attached to the first retaining structure 38 and is in contact with the cathode conductor 124 on the second gas cathode 22 of the next metal-gas cell 12. The cathode conductor 124 is attached to the second retaining structure 42 of the next metal-gas cell. The contact surface 116 of the anode conductor 118 is attached to the inner surface 126. (shown in FIG. 9) of the first wall 78 of the soft pocket 24. The contact surface 116 of the anode conductor 118 tightly contacts the upper portion 64 of the anode support structure 62 by the extruding portion 128 (shown in FIG. 9) of the inner portion of the second wall 82 of the soft pocket 24 to ensure good electrical conductivity.

In FIG. 9, the metal anode 28 is hung within the soft pocket 24 by a hook 117. Hook 117 extends from the contact surface 116 of the anode conductor 118, and hooks the central opening 65 of the upper portion 64 of the electrically conductive support structure 62 of the metal anode 28. The hook 117 is designed to ensure the right position of the metal anode 28. When the metallic anode 28 is inserted into the soft pocket chamber 26, the metal anode 28 is hooked by hook 117 to prevent the metal anode 28 from dropping to the lower portion 94 of the soft pocket 24 and being damaged while the metal-gas cell 12 is in the first retaining structure position, i.e. the metal-gas cell 12 is closed.

In FIG. 9, the two protrusions 168 extended from the inner surface of the first wall 78 of the soft pocket 24 are designed to protect the metal anode 28 and to avoid damaging the anode base portion 72 of the metal anode 28. The damage of the anode base portion 72 of the metal anode 28 can be the result of the hook 117 scratching the anode base portion 72 when the metal anode 28 is inserted into the soft pocket chamber 26.

FIG. 6 is an exploded view of the sub-assembly 32 shown in FIG. 3. FIG. 7 is a cross-sectional view taken along F-F of the sub-assembly 32 of the metal-gas cell shown in FIG. 3. The two extrusions 134 with central ventilating hole 136 of the base plate 132 are respectively inserted into the holes 138 located between the inner surface of the first wall 78 and the second wall 82 of the soft pocket 24. A sealing element 142 with central opening 144, a sheet of gas permeable but liquid impermeable membrane 146, and a plastic cover 148 with two ventilation holes 152 are attached to the base plate 132 for assembly the sub-assembly 32. Such a semi-permeable membrane 146 can be made of Polytetrafluoroethylene (PTFE) or other suitable semi-permeable material. Any gas generated inside the metal-gas cell 12 can be vented through the ventilation holes 136 of the base plate 132, the membrane 146 and the ventilation holes 152 in the cover 148 to the outside of the metal-gas cell 12.

Due to the incline of a conventional metal-gas cell and the rise of the electrolyte during high power output, the semi-permeable membrane in the prior art is often blocked by the electrolyte. Therefore, the vapor pressure built up during operation can cause the electrolyte to leak or even spray out from the top sealing of the conventional metal-gas cell. In this preferred embodiment of the invention, the semi-permeable membrane 146 is moved to the top of the soft pocket chamber 26, and the area of the semi-permeable membrane 146 is enlarged. Hence, there is sufficient space for gas passage to quickly release the internal pressure, built up during high power output, of the metal-gas cell 10. Furthermore, no electrolyte is blocked by the enlarged semi-permeable membrane 146 and no electrolyte leakage occurs. The metal-cell 10 can work normally in any required reasonable position.

FIG. 8 illustrates a cross-sectional view taken along A-A from FIG. 2. Any gas in the upper-most cavity 162 is vented through the ventilation holes 136 in the base plate 132, the membrane 146 and the ventilation holes 152 in the plastic cover 148 to the atmosphere. Thus, the metal-gas cell 12 of this preferred embodiment does not require any breathing holes in the cell housing or in the top of the anode assembly as is common in prior art metal-gas cell designs. According to the design of this embodiment, liquid and mist within the metal-gas cell 12 are wholly contained within the metal-gas cell 12 and are not allowed to leak externally from the metal-gas cell 12.

FIGS. 8 and 9 illustrates how the first gas cathode 18 and the second gas cathode 22 are disposed with respect to one another. The first and the second gas cathodes 18 and 22 are any suitable gas cathodes known in the industry. Typical gas cathodes useable in the invention are manufactured by Power Zinc Electric Inc. Laterally disposed current collectors 156 and 158 are disposed along the top edges of the first and the second gas cathodes 18 and 22, respectively. In the embodiment illustrated in the drawings, two pairs of electrical contacts 112 and 114 extend from both current collectors 156 and 158. When the second retaining structure 42 is disposed in the first retaining structure position, each pair of electrical contacts 112 and 114 are in physical contact with one another. In this way, the first and the second gas cathodes 18 and 22 are electrically connected to one another. Further, a lid extends from the current collector 158 to be the cathode conductor 124. As mentioned before, the extruding portion 128 of the inner portion of the second wall 82 of the soft pocket 24 presses the upper portion 64 of the anode support structure 62 tightly against the conducting surface 116 of the anode conductor 118. The other conducting surface 122 of the anode conductor 118 is tightly pressed against the cathode conductor 124 of the neighbor cell to connect the anode of the first metal-gas cell to the cathode of the next metal-gas cell.

In the conventional metal-gas cell, it is found that any metal conductor extending through the walls of the plastic casing for containing an electrolyte solution can cause unpredictable leakage, no matter whether the metal conductor is molded or glued into the plastic casing. To eliminate potential leakage, as shown in FIGS. 8 and 9, all metal conductors, including the anode conductor 118 and the cathode conductor 124, are extended upward to its right position from the soft pocket 24. It has been proved that the soft pocket 24 can seal any single metal sheet passed through its upper-most opening, even if the cell is turned upside down. Furthermore, the electrical contacts 112 and 114 are extended upward to beyond the top opening 46 of the soft pocket 24, and these electrical contacts 112 and 114 thus are no longer exposed to electrolyte. Moreover, at least one electrical contact of each electrical contacts pair, including electrical contacts 112 and 114, anode conductors 118, and cathode conductors 124, is made with a spring force. Therefore, a good electrical transmission is more reliably guaranteed.

As further illustrated in FIG. 9, the metal-gas cell 12 of the preferred embodiment operates with an electrolyte 164 disposed within the soft pocket chamber 26. The electrolyte 164 is typically an aqueous solution of potassium hydroxide, sodium hydroxide or sodium chloride. In order to avoid the growth of the zinc dendrites on the anode, the electrolyte has to be nearly saturated with zinc oxide, preferably 20-50 g/L, most preferably 35-40 g/L. The electrolyte 164 is disposed within a lower portion 94 of the soft pocket chamber 26. That portion of the soft pocket chamber 26 above the liquid level 166 of the electrolyte 164 is referred to herein as the upper portion 96 of the soft pocket chamber 26.

There are four elbow tubes 172 respectively located at four corners of the first and the second separators 89 and 93, as shown in FIGS. 10 and 11. In FIGS. 10 and 11, one end of the elbow tube 172 is located in the gap between the first separator 89 and the first gas cathode 18; the other end of the elbow tube 172 passes through the hole 174 on the first separator 89 and the hole 176 on the first wall 78. Gas bubbles always appear in gaps between, for example, the first separator 89 and the first gas cathode 18 while discharge. The accumulation of gas in the gaps seriously reduces the effective area of the first gas cathode 18. Therefore, the performance of the cell is lowered. The two elbow tubes 172 located at the two upper corners of the first separator 89 can allow any gas bubbles in the gap to enter the space between the first separator 89 and the metal anode 28. The two elbow tubes 172 located at the two lower corners of the first separator 89 allow the electrolyte entering into the gap between the separator and gas cathode to create the electrolyte flow.

The invention provides a metal-gas battery, such as a zinc-air battery, which is suitable for rapid refueling, is easier to assemble, is lighter and is sufficiently durable for hundreds of refueling operations. The invention also provides a metal-gas battery that does not leak electrolyte or electrolyte mist. In order to avoid the unpredicted leakage of electrolyte, the gas diffusion electrodes are installed on a soft pocket instead of a rigid cell housing to eliminate the stress created by different coefficients of thermal expansion of various materials. Therefore, the metal-gas battery provided by this invention can be applied to various products, such as electric bike, electric scooter, electric motorcycle, electric car, electric bus, electric tricycle, electric van, etc.

Having thus described the invention, it should be apparent that numerous structural modifications and adaptations may be resorted to without departing from the scope and fair meaning of the instant invention as set forth herein above and as described herein below by the claims.

What is claimed is:

1. A metal-gas battery comprising at least one metal-gas cell, wherein each metal-gas cell comprises:
a soft pocket having two flexible and planar walls, wherein peripheries of the two walls are connected except along respective top edges of the two walls, the soft pocket being made of an elastic and alkaline-resistant material;
two groups of threads being vertically arranged and respectively glued onto the peripheries of the two walls of the soft pocket to form gas passage between adjacent threads;
two gas cathodes glued to the two walls of the soft pocket, respectively, the two gas cathodes being permeable to air but impermeable to liquids to allow gases to enter the metal-gas cell, and the two gas cathodes being electrically connected to each other, whereby the two gas cathodes and the two walls of the soft pocket cooperate to define a liquid retaining soft pocket chamber having a lower portion, an upper portion and a top opening defined between the top edges of the two walls of the soft pocket;
two soft plates with a central opening used to help to seal the two gas cathodes to the two walls of the soft pocket, respectively, the two soft plates being made of a same material as the soft pocket;
a rigid planar first retaining structure and a rigid planar second retaining structure attached to the peripheries of the two walls of the soft pocket, respectively, the second retaining structure being moveable with respect to the first retaining structure between a first retaining structure position, wherein the first retaining structure is proximal to the second retaining structure to close tightly the top opening of the soft pocket chamber, and a second retaining structure position, wherein the first retaining structure is spaced apart from the second retaining structure to open the top opening of the soft pocket chamber;
a metal anode disposed within the soft pocket chamber;
two sheets of separator permanently and respectively installed between each pair of the gas cathode and the group of threads, respectively; and
a sub-assembly, located in an upper-most position of the metal-gas cell, being permeable to air but impermeable to liquids in order to reduce a pressure difference between the soft pocket chamber and an outside atmosphere.

2. The metal-gas battery of claim 1, wherein the metal-gas cell further comprises an electrolyte disposed within the soft pocket chamber.

3. The metal-gas battery of claim 2, wherein the electrolyte is saturated with zinc oxide at a concentration of about 20-50 g/L.

4. The metal-gas battery of claim 2, wherein the electrolyte is saturated with zinc oxide at a concentration of about 35-40 g/L.

5. The metal-gas battery of claim 2, wherein the electrolyte is an aqueous solution containing a compound chosen from a group consisting of potassium hydroxide, sodium hydroxide and sodium chloride.

6. The metal-gas battery of claim 2, wherein the electrolyte is an aqueous solution containing potassium hydroxide.

7. The metal-gas battery of claim 1, wherein the two groups of threads are made of a plastic and alkaline-resistant material.

8. The metal-gas battery of claim 1, wherein the two groups of threads are made of polypropylene or nylon.

9. The metal-gas battery of claim 1, wherein a semi-permeable membrane is disposed in the sub-assembly to allow gases to flow out from the upper portion of the soft pocket through the sub-assembly, the semi-permeable membrane being permeable to gases but being impermeable to liquids.

10. The metal-gas battery of claim 9, wherein the semi-permeable membrane is made of PTFE.

11. The metal-gas battery of claim 1, wherein all edges of the metal anode are rounded to avoid dropping metal powder.

12. The metal-gas battery of claim 1, wherein the metal anode comprises an electrically conductive support structure with a metal anode material attached thereto, and the support structure has a lower portion and an upper portion.

13. The metal-gas battery of claim 12, further comprising a plurality of internal metal-gas cells sandwiched between a first outermost metal-gas cell and a second outermost metal-gas cell, the upper portion of the metal anode in each of the internal metal-gas cells being electrically connected to gas cathodes of an adjoining metal-gas cell by an anode conductor.

14. The metal-gas battery of claim 1, wherein the metal anode is hung firmly within the soft pocket by a hook when the first and the second retaining structures are in the first retaining structure position.

15. The metal-gas battery of claim 14, wherein the hook is attached to the first retaining structure.

16. The metal-gas battery of claim 1, wherein the soft pocket is made of thermoplastic rubber or thermoplastic elastomer.

17. The metal-gas battery of claim 1, wherein the soft pocket is made of polypropylene, neoprene, ethylene propylene diene monomer, butyl rubber, ethylene propylene copolymer, or chlorosulfonated polyethylene.

18. The metal-gas battery of claim 1, wherein the soft pocket is made of polypropylene or ethylene propylene diene monomer.

19. The metal-gas battery of claim 1 further comprising eight elbow tubes respectively located at four corners of the two separators, one end of each elbow tube is located in the gap between each pair of the separator and the gas cathode, and the other end of each elbow tube passes through a hole on each separator and a hole on each wall of the soft pocket.

20. The metal-gas battery of claim 1 comprising a plurality of metal-gas cells.

21. The metal-gas battery of claim 20, wherein the metal-gas cells are electrically connected in series.

22. The metal-gas battery of claim 1, wherein the two gas cathodes are electrically connected by at least a pair of metal contacts extended upward above the top opening of the soft pocket.

23. A zinc-air battery comprising:
(a) a plurality of internal zinc-air cells sandwiched between a first outermost zinc-air cell and a second outermost zinc-air cell, each zinc-air cell comprising:
a soft pocket having two flexible and planar walls, wherein peripheries of the two walls are connected except along respective top edges of the two walls, the soft pocket being made of an elastic and alkaline-resistant material;
two groups of threads being vertically arranged and respectively glued onto the peripheries of the two walls of the soft pocket to form air passage between adjacent threads;
two air cathodes glued to the two walls of the soft pocket, respectively, the two air cathodes being permeable to air but impermeable to liquids to allow air to enter the zinc-air cell, and the two air cathodes being electrically connected to each other, whereby the two air cathodes and the two walls of the soft pocket cooperate to define a liquid retaining soft pocket chamber having a lower portion, an upper portion and a top opening defined between the top edges of the two walls of the soft pocket;
two soft plates with a central opening used to help to seal the two air cathodes to the two walls of the soft pocket, respectively, the two soft plates being made of a same material as the soft pocket;
a rigid planar first retaining structure and a rigid planar second retaining structure attached to the peripheries of the two walls of the soft pocket, respectively, the second retaining structure being moveable with respect to the first retaining structure between a first retaining structure position, wherein the first retaining structure is proximal to the second retaining structure to close tightly the top opening of the soft pocket chamber, and a second retaining structure position, wherein the first retaining structure is spaced apart from the second retaining structure to open the top opening of the soft pocket chamber;
a zinc anode disposed within the soft pocket chamber;
two soft plates with a central opening used to help to seal the two air cathodes to the two walls of the soft pocket, respectively, the two soft plates being made of a same material as the soft pocket; and
a sub-assembly, located at the upper-most position of the zinc-air cell, being permeable to air but impermeable to liquids in order to reduce a pressure difference between the soft pocket chamber and an outside atmosphere;
(b) a positive battery terminal electrically connected to the two air cathodes of the first outermost zinc-air cell; and
(c) a negative battery terminal electrically connected to the zinc anode of the second outermost zinc-air cell;
wherein an upper portion of the zinc anode in each internal zinc-air cell is electrically connected to air cathodes of an adjoining zinc-air cell by an anode conductor.

24. The zinc-air battery of claim 23, wherein each zinc-air cell further comprises an electrolyte disposed within the soft pocket chamber.

25. The zinc-air battery of claim 24, wherein the electrolyte is saturated with zinc oxide at a concentration of about 20-50 g/L.

26. The zinc-air battery of claim 24, wherein the electrolyte is saturated with zinc oxide at a concentration of about 35-40 g/L.

27. The zinc-air battery of claim 24, wherein the electrolyte is an aqueous solution containing a compound chosen from a group consisting of potassium hydroxide, sodium hydroxide and sodium chloride.

28. The zinc-air battery of claim 24, wherein the electrolyte is an aqueous solution containing potassium hydroxide.

29. The zinc-air battery of claim 23, wherein the two groups of threads are made of a plastic and alkaline-resistant material.

30. The zinc-air battery of claim 23, wherein the two groups of threads are made of polypropylene or nylon.

31. The zinc-air battery of claim 23, wherein a semi-permeable membrane is disposed in the sub-assembly to allow air to flow out from the upper portion of the soft pocket through the sub-assembly, the semi-permeable membrane being permeable to air but being impermeable to liquids.

32. The zinc-air battery of claim 24, wherein the semi-permeable membrane is made of PTFE.

33. The zinc-air battery of claim 23, wherein all edges of the zinc anode are rounded to avoid dropping zinc powder.

34. The zinc-air battery of claim 23, wherein the zinc anode comprises an electrically conductive support structure with zinc powder attached thereto, and the support structure has a lower portion and an upper portion.

35. The zinc-air battery of claim 23, wherein the zinc anode is hung firmly within the soft pocket by a hook when the first and the second retaining structures are in the first retaining structure position.

36. The zinc-air battery of claim 35, wherein the hook is attached to the first retaining structure.

37. The zinc-air battery of claim 23, wherein the soft pocket is made of thermoplastic rubber or thermoplastic elastomer.

38. The zinc-air battery of claim 23, wherein the soft pocket is made of polypropylene, neoprene, ethylene propylene diene monomer, butyl rubber, ethylene propylene copolymer, or chlorosulfonated polyethylene.

39. The zinc-air battery of claim 23, wherein the soft pocket is made of polypropylene or ethylene propylene diene monomer.

40. The zinc-air battery of claim 23 further comprising eight elbow tubes respectively located at four corners of the two separators, one end of each elbow tube is located in the gap between each pair of the separator and the air cathode, and the other end of each elbow tube passes through a hole on each separator and a hole on each wall of the soft pocket.

41. The zinc-air battery of claim 23, wherein the zinc-air cells are electrically connected in series.

42. The zinc-air battery of claim 23, wherein the two air cathodes are electrically connected by at least a pair of metal contacts extended upward above the top opening of the soft pocket.
